(19) United States
(12) Patent Application Publication
(10) Pub. No.: US 2026/0301745 A1
(43) Pub. Date: Oct. 1, 2026

(54) Systems and Methods for Personalized Sound Localization in a Conversation

(71) Applicant: Google LLC, Mountain View, CA (US)

(72) Inventors: Dimitri Kanevsky, Ossining, NY (US); Artem Dementyev, Newton, MA (US); Sagar Savla, San Francisco, CA (US); Sharlene Yuan, Taipei (TW); Samuel Jialuo Yang, Mountain View, CA (US); Perrin Anto, New York, NY (US); Alex Olwal, Santa Cruz, CA (US); Tien-Chi Huang, Taipei (TW); Chet Nicholas Gnegy, Taipei (TW); Yun Che Chung; Richard Francis Lyon, Los Altos, CA (US)

(21) Appl. No.: 19/478,686

(22) PCT Filed: Apr. 24, 2023
(86) PCT No.: PCT/US2023/019559

§ 371 Date: Oct. 24, 2025

(51) Int. Cl. G10L 17/02; G06F 40/103; G06F 40/166; G10L 25/06

(52) U.S. Cl. CPC G10L 17/02; G06F 40/103; G06F 40/166; G10L 25/06

(57) ABSTRACT

An example method includes receiving first and second audio signals from respective first and second audio input devices. The first and second audio signals correspond to speech input of a conversation between two participants. The method includes estimating, based on the first and second audio signals, a time delay in respective arrival times for the speech input at the first and second audio input devices. The method includes estimating respective directions for two audio sources based on the estimated time delay in the respective arrival times. The method includes associating, based on the estimated directions of the two audio sources, respective portions of a speech-to-text transcript of the conversation with the respective participants. The method includes displaying based on the associating of the respective portions, a modified speech-to-text transcript of the conversation that labels the respective portions of the speech-to-text transcript associated with the respective participants.

### BACKGROUND

Many modern computing devices, including mobile phones, personal computers, and tablets, include on-device input recognition capabilities. The devices can capture and transcribe speech inputs and provide the transcription to one or more downstream applications.

Mobile phone applications are limited in the amount of available computational resources. Accordingly, enabling user access to efficient input recognition tools, while utilizing low computational resources, is a significant technological challenge.

### SUMMARY

Speech from a group conversation may be transcribed in real-time and presented via display devices. A useful feature of such a transcription is to be able to identify the individual participants in the group conversation, and label the transcription so as to reflect the participants corresponding to different portions of the transcription. Another useful feature is to provide a visual display of the participants and their respective physical locations as they participate in the group conversation. Some individual participants may utter speech in different ways. For example, some participants may have accents, and others may have speech characteristics that may cause variations in their uttered speech. A general speech recognition transcription may reflect such utterances as errors in transcription. Accuracy of on-device recognition of user input can be challenging when the input includes terms that are not recognized as common terms. For example, when the input is in the form of speech, one or more phrases may be pronounced in a way that significantly depends on the participant. In some instances, phonetic variations of phrases, or misspellings of terms, grammatical preferences, and so forth, can be personal to the user (e.g., names, locations, proper nouns, input by the user). Use of personalized speech recognition models can improve speech recognition accuracy. This depends on fast and efficient identification of different participants so that an acoustic model appropriate for a particular participant may be utilized.

In one aspect, a computer-implemented method is provided. The method includes receiving, by a computing device, first and second audio signals from respective first and second audio input devices, wherein the first and second audio signals correspond to speech input of a conversation between two participants. The method further includes estimating, by the computing device and based on the first and second audio signals, a time delay in respective arrival times for the speech input at the first and second audio input devices. The method additionally includes estimating, by the computing device, respective directions for two audio sources based on the estimated time delay in the respective arrival times. The method also includes associating, based on the estimated directions of the two audio sources, respective portions of a speech-to-text transcript of the conversation with the respective participants. The method further includes displaying, by the computing device and based on the associating of the respective portions, a modified speech-to-text transcript of the conversation that labels the respective portions of the speech-to-text transcript associated with the respective participants.

In another aspect, a computing device is provided. The computing device includes one or more processors and data storage. The data storage has stored thereon computer-executable instructions that, when executed by one or more processors, cause the computing device to carry out functions. The functions include receiving, by the computing device, first and second audio signals from respective first and second audio input devices, wherein the first and second audio signals correspond to speech input of a conversation between two participants. The functions further include estimating, by the computing device and based on the first and second audio signals, a time delay in respective arrival times for the speech input at the first and second audio input devices. The functions additionally include estimating, by the computing device, respective directions for two audio sources based on the estimated time delay in the respective arrival times. The functions also include associating, based on the estimated directions of the two audio sources, respective portions of a speech-to-text transcript of the conversation with the respective participants. The functions further include displaying, by the computing device and based on the associating of the respective portions, a modified speech-to-text transcript of the conversation that labels the respective portions of the speech-to-text transcript associated with the respective participants.

In another aspect, an article of manufacture is provided. The article of manufacture includes one or more computer readable media having computer-readable instructions stored thereon that, when executed by one or more processors of a computing device, cause the computing device to carry out functions. The functions include receiving, by the computing device, first and second audio signals from respective first and second audio input devices, wherein the first and second audio signals correspond to speech input of a conversation between two participants. The functions further include estimating, by the computing device and based on the first and second audio signals, a time delay in respective arrival times for the speech input at the first and second audio input devices. The functions additionally include estimating, by the computing device, respective directions for two audio sources based on the estimated time delay in the respective arrival times. The functions also include associating, based on the estimated directions of the two audio sources, respective portions of a speech-to-text transcript of the conversation with the respective participants. The functions further include displaying, by the computing device and based on the associating of the respective portions, a modified speech-to-text transcript of the conversation that labels the respective portions of the speech-to-text transcript associated with the respective participants.

In another aspect, a system is provided. The system includes means for receiving, by a computing device, first and second audio signals from respective first and second audio input devices, wherein the first and second audio signals correspond to speech input of a conversation between two participants; means for estimating, by the computing device and based on the first and second audio signals, a time delay in respective arrival times for the speech input at the first and second audio input devices; means for estimating, by the computing device, respective directions for two audio sources based on the estimated time delay in the respective arrival times; means for associating, based on the estimated directions of the two audio sources, respective portions of a speech-to-text transcript of the conversation with the respective participants; and means for displaying, by the computing device and based on the associating of the respective portions, a modified speech-to-text transcript of the conversation that labels the respective portions of the speech-to-text transcript associated with the respective participants.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 illustrates a computing device for speaker identification based on sound localization, in accordance with example embodiments.

FIG. 2A illustrates localization with two microphones, in accordance with example embodiments.

FIG. 2B illustrates example audio input components of a computing device for sound localization, in accordance with example embodiments.

FIG. 2C illustrates localization with three microphones, in accordance with example embodiments.

FIG. 3 illustrates example sample audio signals captured by three audio input devices, in accordance with example embodiments.

FIG. 4A illustrates an example for sound localization, in accordance with example embodiments.

FIG. 4B illustrates an example flowchart for speaker identification, in accordance with example embodiments.

FIG. 5 illustrates an example split-screen display for speaker identification based on sound localization, in accordance with example embodiments.

FIG. 6 is a diagram illustrating training and inference phases of a machine learning model, in accordance with example embodiments.

FIG. 7 depicts a distributed computing architecture, in accordance with example embodiments.

FIG. 8 is a block diagram of a computing device, in accordance with example embodiments.

FIG. 9 is a flowchart of a method, in accordance with example embodiments.

FIG. 10 is a flowchart of another method, in accordance with example embodiments.

### DETAILED DESCRIPTION

### Overview

Speech-to-text capabilities on mobile devices are helpful for hearing and speech accessibility, language translation, note taking, transcribing meetings, and so forth. However, the usefulness of such capabilities is constrained by an inability to distinguish between multiple speakers, tracking which direction speech is coming from, and providing acceptable performance in noisy environments.

In the context of speech-to-text transcription, diarization methods separate the speech according to the speakers. Such methods are generally not accurate and are slow. For example, existing methods are based on relatively long utterances to identify a speaker. Another challenge is that speech recognition apps in smartphones, when used in public spaces, may transcribe individuals who are not participants in a conversation.

Some real-time diarization techniques are based on dedicated microphone clips that are attached to each speaker. Such approaches are not suitable for applications with off-the-shelf mobile phones. Some transcription software provide diarization that cannot be performed in real-time, and/or may depend on network connectivity. Real-time diarization may be performed using deep learning models based on d-vectors, and these can provide a unique acoustic signature. Such techniques can be useful in a single microphone setting. However, the d-vector approach may involve privacy shortcomings, and can have higher compute and latency costs.

As described herein, sound localization techniques and beamforming on embedded multi-microphone hardware may be used at a mobile device to identify a sound source corresponding to speakers (or participants) in a conversation, and then apply a speech characteristics diarization (e.g., a personalized speech recognition model) to the participants located in directions corresponding to their identified sound sources. The device combines the speech characteristics diarization based on acoustic characteristics (e.g. d-vector/speaker embeddings followed by clustering or principal components analysis) and sound localization to improve the detection of a speaker turn or identification of a speaker identity (ID).

As an example, a person may have hearing challenges, and/or may not be proficient in a particular language. Such a person may use an application on their mobile device for real-time speech-to-text. However, such an application would be unable to distinguish between speakers, and the transcription may be a concatenation of the speech into a single paragraph, making it difficult for the individual to follow. Additionally, as the person is more likely to be viewing the display on their mobile device, they may not be able to track speaker changes effectively. For example, the person will likely struggle to follow the turn taking among the participants in the conversation. Finally, the text generated by automatic speech recognition (ASR) may be difficult to understand since background noise may introduce errors.

Generally, such challenges arise from spatial complexities of audio, and a single microphone in ASR may not be able to perceive such complexities. Accordingly, an array of multiple microphones may be used, and techniques for microphone array signal processing may be applied to improve ASR. For example, a speech-to-text transcript may visually separate different speakers, based on the direction of the speech. For spatial sound visualization, the screen may display the direction of the source of the sound. For selective attention and speech enhancement, the user may be provided with an ability to select sound sources of interest. Beamforming may be used to enhance audio coming from certain directions and suppress audio from non-selected directions.

Microphone array processing has been generally limited to high-end audio applications, because it is computationally intensive to meet the latency and power consumption requirements for mobile and/or wearable devices. However, recent advances in computational power allow such techniques to be used in low-power devices with low latency as well. Accordingly, low-latency localization and beamforming algorithms are described herein. For example, 180-degree localization is possible using an existing two-microphone placement on an off-the-shelf mobile phone with no additional hardware.

As described herein, TDOA (time-difference-of-arrival) for pairs of microphones may be used to localize speakers in space, and perform diarization. When combined with personalized, secure, on-device acoustic models, transcriptions can be generated with a high degree of accuracy, participants may be reliably identified, while not requiring network connectivity, and while maintaining heightened privacy controls. Approaches that rely on beamforming and TDOA from multiple microphones have lower compute needs and lower latency when compared to deep learning methods.

Optimized embedded algorithms for sound localization and beamforming are described that run on a low-power microcontroller with real-time performance (<20 ms latency). A multi-microphone hardware prototype is described that uses a microcontroller for real-time sound localization and beamforming, an LED array to indicate sound direction, and buttons to select the sound source. The prototype may be configured for multi-channel audio over USB-C, localization data over USB-C, and provide analog audio over the headphone jack.

In some examples, a trained machine learning model can work on a variety of computing devices, including but not limited to, mobile computing devices (e.g., smart phones, tablet computers, cell phones, laptop computers), stationary computing devices (e.g., desktop computers), and server computing devices.

A machine learning model, such as a convolutional neural network, can be trained using training data (e.g., speech data) to perform one or more aspects as described herein. In some examples, the neural network can be arranged as an encoder/decoder neural network.

A trained machine learning model can process the input data to predict an output data comprising one or more words and/or phrases that are associated with the input data. In one example, (a copy of) the trained neural network can reside on a mobile computing device. In some embodiments, the mobile computing device can include a microphone that can capture input voice data. In response, the trained neural network can generate a predicted output word that is associated with the input voice data.

In some embodiments, a first trained machine learning model can perform input recognition to generate a transcription of an input, and a second trained machine learning model can perform personalization of the transcription based on speaker-based acoustic models. Although the personalization and labeling of the transcription is performed by an on-device system, the speech recognition can be performed by a remote server. In such embodiments, the on-device system can receive the speech and send the speech to the remote server. The remote server can apply the first trained machine learning model to generate the transcription of the speech. Subsequently, the on-device system can receive the transcription from the remote server, and perform the personalization and labeling of the transcription.

As such, the herein-described techniques can improve speech recognition by accurately identifying speakers based on estimation of audio sources, comparison of speech characteristics, or both. Enhancing the actual and/or perceived quality of speech recognition can provide benefits to downstream applications that depend on an output of a speech recognition system (e.g., voice enabled applications). These techniques are flexible, and so can apply a wide variety of user input such as human voices, including various languages, dialects, and accents.

### Localized Speech Recognition

An on-device transcription system is described. For example, sound localization is utilized to identify a participant or a change in participant during a conversation, and by choosing acoustic models for participants that are located in directions corresponding to their sound sources.

In some aspects, a user can identify locations of participants in a meeting on a digital image that captures individuals in the meeting. In this case cameras may be used to capture digital images of users in the meeting, and also to detect movement of users (e.g., changing seats at a conference table).

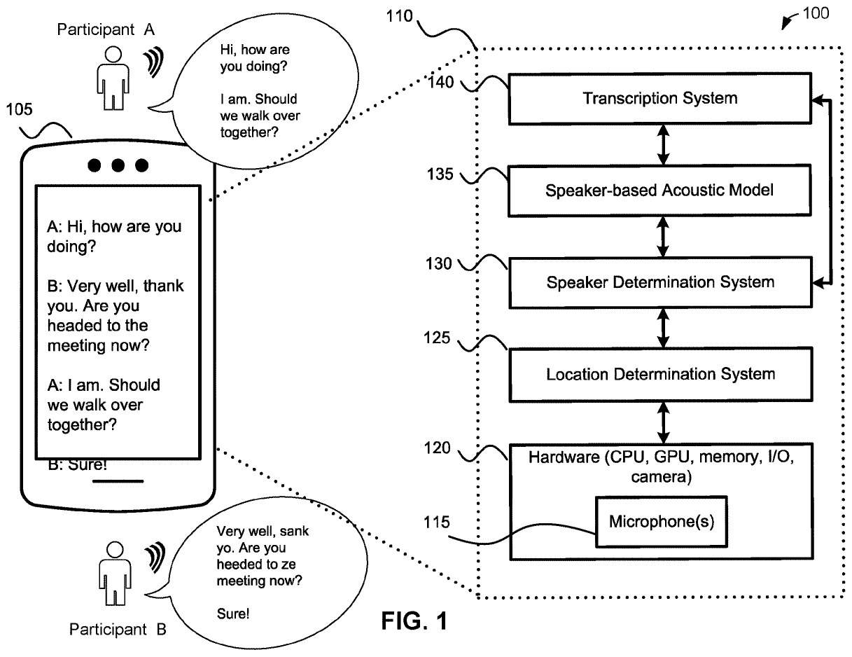

FIG. 1 illustrates a computing device 100 for participant identification based on sound localization, in accordance with example embodiments. Device 105 may be configured with an on-device system 110 that can include the one or more components that perform the functions described herein. Two or more individuals may be participating in a group conversation and device 105 may capture the conversation and transcribe the speech. Device 105 may include one or more audio input devices, such as microphone(s) 115. Although microphone(s) 115 are shown as part of hardware 120 of device 105, this is for purposes of illustration only. One or more of microphone(s) 115 may be located on device 105. However, microphone(s) 115 may be external audio input devices that capture the conversation. For example, a conference room may include microphone(s) 115 installed at various locations to capture the conversation, and the captured speech can be converted to an audio signal (for each microphone) and be transmitted to device 105.

Device 105 may include computing devices such as a laptop, a desktop computer, a smart television, an electronic reading device, a streaming content device, a gaming console, a tablet device, or other related computing devices that are configured to execute software instructions and application programs.

In some embodiments, on-device system 110 can be configured to run on an operating system of device 105. On-device system 110 can include an interface (e.g., by an application programming interface (API)) to communicate with one or more application programs on device 105. For example, on-device system 110 can communicate with an automatic speech recognition system, and/or a transcription system, one or both of which may be located on a cloud server.

On-device system 110 can interface with one or more hardware components 120 (e.g., a central processing unit (CPU), a graphics processing unit (GPU), memory, input and/or output devices, and/or camera(s) of device 105). For example, on-device system 110 can interface with one or more cameras, or with microphone(s) 115. In some embodiments, the speech input by the user can be captured by microphone(s) 115. Microphone(s) 115 may be a part of device 105, or may be an audio input device (e.g., a wired or wireless microphone) separate from device 105, and communicatively linked to device 105.

Device 105 may be configured to receive first and second audio signals from respective first and second audio input devices (e.g., microphone(s) 115). The first and second audio signals correspond to speech input of a conversation between two participants (e.g., participants A and B). In situations where microphone(s) 115 are in close proximity to one another, they will receive substantially the same speech, and therefore generate substantially similar audio signals. However, if microphone(s) 115 are located at a distance apart from one another, each may identify a different audio signal for the same conversation. Consider the situation, where microphone(s) 115 are two microphones, say M1 and M2, located at or near the top and bottom of a smartphone. The two participants, say A and B, may be seated across from each other, with participant A closer to microphone M1, and participant B seated closer to microphone M2. Accordingly, as the conversation proceeds, microphone M1 will likely receive participant A's speech signal earlier than participant B's speech signal, whereas, microphone M2 will likely receive participant B's speech signal earlier than participant A's speech signal.

Generally, microphone M1 that is farther from a sound source (e.g., participant B) is likely to generate a relatively lower amplitude and/or slightly phase delayed signal relative to microphone M2 that is closer to the sound source (e.g., participant B). Similar logic applies to microphone M2 and participant A. Upon temporal synchronization of the audio signals from microphones M1 and M2, respective delays with respect to each participant may be detected. Localization is computationally intensive, the delay between each unique pair of microphones is estimated. The delay estimation may be performed using cross-correlation. For example, generalized cross-correlation with phase transform (GCC-PHAT) may be applied to the synchronized first and second audio signals. In some examples, the following relationship may be utilized:

$$G ( f ) = {ℱ}^{- 1} ( \frac{{{X}_{1} ( f ) [ {X}_{2} ( f ) ]}^{*}}{{( \vert {{X}_{1} ( f ) [ {X}_{2} ( f ) ]}^{*} \vert )}^{β}} ) \qquad ( Eqn . 1 )$$

where X₁(f) and X₂(f) are the Fourier transforms of the synchronized first and second audio signals, [ ]* denotes a complex conjugate, [symbol] ⁻¹ is the inverse Fourier transform, and G(f) is the resulting cross-correlation. In some embodiments, GCC-PHAT may be modified by applying a partial normalization with β=−0.3 for increased noise robustness.

The time delay between two microphones (e.g., microphones M1 and M2) may be determined from the cross-correlation based on the following relationship:

$$Δ t = \frac{arg max ( G ( f ) )}{{f}_{s}} \qquad ( Eqn . 2 )$$

where fₛ is the audio sampling frequency (44.1 kHz), and argmax is the index of the maximum peak in the cross-correlation, corresponding to delay in samples. To convert the time delay into an azimuth angle (horizontal angle on the microphone plane), the microphone spacing can be used to calculate the maximum delay:

$$Δ {t}_{max} = \frac{Δ d}{c} \qquad ( Eqn . 3 )$$

where c=343 m/s is the speed of sound, and Δd is the distance between the microphones.

Assuming far-field sound waves, a formula as shown below may be used to calculate the azimuth angle. The far-field approximation assumes planar sound waves and is valid approximately when the microphone is a meter or more away from the audio source.

$${θ}_{a z i m u t h} = {cos}^{- 1} ( \frac{Δ t}{Δ {t}_{max}} ) \qquad ( Eqn . 4 )$$

Generally speaking, there may be a possibility of front-back confusion with two microphones. For example, different sources positioned at an inverse angle about the microphone pair axis will likely have a similar TDOA. In some embodiments, three or more microphones that are not positioned on the same line, may be needed to determine a 360-degree azimuth angle.

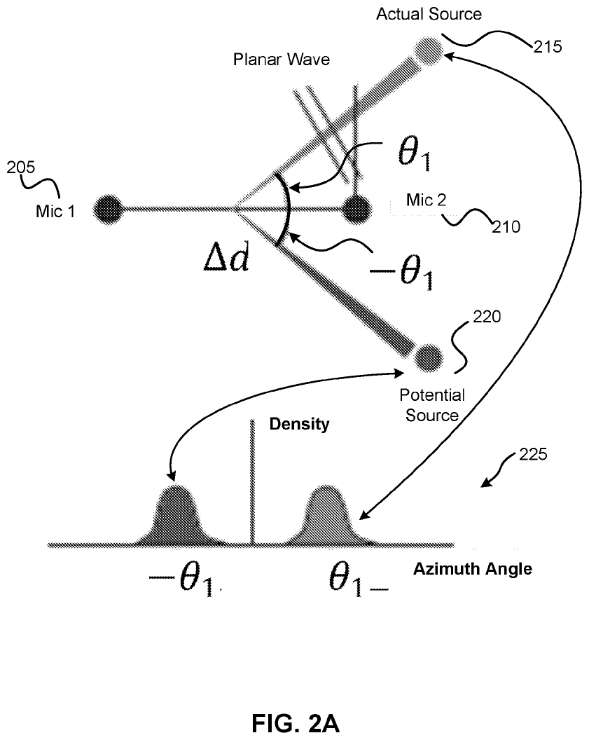

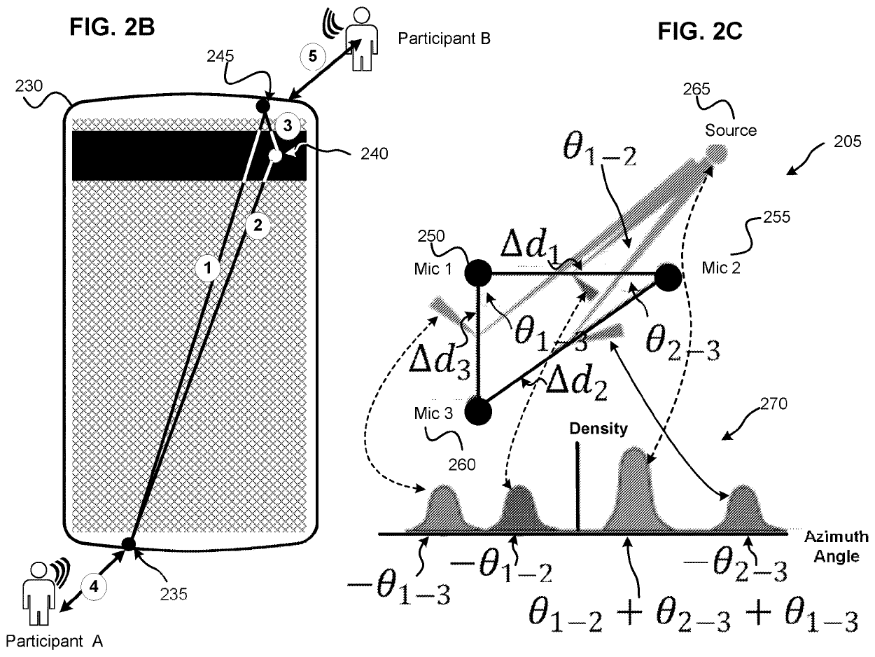

FIG. 2A illustrates localization with two microphones, in accordance with example embodiments. The sound will arrive at microphone two, mic 2 210, before microphone one, mic 1 205. This time difference may be used to estimate an angle of arrival, θ₁. However, with two microphones, there may be some potential ambiguity, as an actual source 215 may appear to be at an inverse angle, −θ₁, and shown as a potential source 220. The graph 225 illustrates a kernel density estimation (KDE) with the actual source 215 and the potential source 220. The horizontal axis of the graph represents the azimuth angle and the vertical axis represents the kernel density. Such angle ambiguity may be fixed with three microphones. The KDE from multiple microphone pairs will have the highest peak at the correct source, as illustrated in FIG. 2C.

FIG. 2B illustrates example audio input components of a computing device for sound localization, in accordance with example embodiments. Device 230 is shown with three microphones. For example, device 230 can be a smartphone, and a view of the rear side of the smartphone is illustrated. Device 230 is shown to be configured with three microphones 210, 215, and 220. Microphones 215 and 220 are located proximate to each other near the top of device 230, whereas microphone 235 is located near the bottom of device 230, at some distance away from microphones 215 and 220. Participant A may be located proximate to microphone 235, whereas participant B may be located proximate to microphones 215 and 220. Pairwise distances between the three microphones 210, 215, and 220 are known, as indicated by the three edges edge labeled “1” (distance between microphones 210 and 220), “2” (distance between microphones 210 and 215), and “3” (distance between microphones 215 and 220).

Also, for example, distances between each participant and device 230 may be determined. For example, arrow “4” captures the first distance between participant A and the bottom of device 230, whereas arrow “5” captures a second distance between participant B and the top of device 230. Device 230 can record audio of the conversation between the two participants A and B. A time-difference-of-arrival (TDOA) may be determined for each pair of microphones. For example, TDOA may be determined on every 12 millisecond (ms) window. In some embodiments, an average TDOA across a segment of audio may be determined, and this can be associated with a word in the audio signal.

FIG. 2C illustrates localization with three microphones, in accordance with example embodiments. Three microphones, mic 1 250, mic 2 255, and mic 3 260, are shown. The distance between mic 1 250, and mic 2 255, may be denoted as Δd₁ and the angle between them may be denoted as θ₁₋₂. Similarly, the distance between mic 2 255, and mic 3 260, may be denoted as Δd₂ and the angle between them may be denoted as θ₂₋₃, and the distance between mic 1 250, and mic 3 260, may be denoted as Δd₃ and the angle between them may be denoted as θ₁₋₃.

Due to the uncertainties of sound propagation, a statistical approach may be used to determine an actual source location (e.g., source 265). For example, the TDOA for each microphone pair (six unique pairs for four microphones) may be determined, and a second potential TDOA may be added. A coordinate transform may be applied so that each angle of arrival is aligned with global azimuth angles. Subsequently, a kernel density estimate (KDE) with a Gaussian kernel (e.g., bandwidth=25) with the 600 latest samples may be applied. Generally, a highest peak will likely correspond to the angle of arrival. As shown in graph 270, the highest peak indicates source 265. Graph 270 comprises a horizontal axis that represents azimuth angle, and a vertical axis that represents density. The KDE may be wrapped around 0 and 360 degrees to address a discontinuity around 0/360 degrees.

Although more resource intensive techniques, including advanced machine learning models, can be applied to identify participants during a conversation, such techniques involve higher compute resources, may require dedicated microphone clips attached to each participant, may depend on network connectivity, and may fail to identify participants in real-time as a conversation unfolds. A more efficient technique may be employed based on a time-difference-of-arrival (TDOA) for pairs of microphones.

Accordingly, on-device system 110 can interface with location determination system 125. Location determination system 125 can be configured to estimate a time delay in respective arrival times for the speech input at the first and second audio input devices. For example, localization based on cross-correlation of the first and second audio signals (or pairs of audio signals in the case of more than two audio input devices) can result in faster compute time, and can be performed on device 105, as it involves signal processing. As such, there is no need for dedicated microphones attached to individual participants, or availability of network connectivity. Many mobile devices are equipped with two microphones. These two microphones can be leveraged to generate the first and second audio signals and determine the time delay in respective arrival times for the speech input at the first and second audio input devices. Also, for example, when device 105 is configured with two microphones 115 (e.g., at the top and bottom of device 105), cross-correlation for localization can be used.

Location determination system 125 can be configured to estimate respective directions for two audio sources based on the estimated time delay in the respective arrival times. In the aforementioned example of two participants, participants A and B, seated across from each other, at opposite ends of device 105, with microphones M1 and M2, cross-correlation for localization can be used to estimate two different audio sources, such as sources corresponding to participants A and B. Accordingly, device 105 is able to identify that the conversation is between two individuals. Although this example is based on two microphones, for additional microphones capturing the conversation, the time delay can be determined for each microphone pair. For example, three microphones result in three unique pairs, and four microphones result in six unique pairs, and so forth. Similarly, where there are more than two participants in the conversation, the time delay in respective arrival times for the audio signal can be used to identify the three audio sources.

As illustrated in FIG. 1, participant A may say, “Hi, how are you doing?” and participant B may respond, “Very well, sank yo. Are you heeded to ze meeting now?” Microphone(s) 115 may receive this speech input, and each microphone may convert this speech input to an audio signal. Location determination system 125 may estimate the audio sources by determining a time delay between these audio signals. In the event device 105 is associated with participant B, speaker-based acoustic model 135 may be configured to predict speech characteristics of participant B. Accordingly, based on one or both of the estimated audio sources and the predicted speech characteristics, speaker determination system 130 may identify that there are two speakers, and also identify one of the two speakers as participant B (based on predicted speech characteristics). Transcription system 140 may then transcribe the input speech. In particular, in conjunction with speaker-based acoustic model 135, transcription system 140 may be able to accurately transcribe the words or phrases accurately. For example, the phrase “sank yo” is transcribed to “thank you,” the word “heeded” is transcribed to “headed” (e.g., contextual information can be utilized), and the phrase “ze meeting” is transcribed to “the meeting.”

Accordingly, transcription system 140 transcribes the speech input and outputs a labeled transcript as “A: Hi, how are you doing?, B: Very well, thank you. Are you headed to the meeting now?”. The remainder of the conversation may be transcribed in like manner, and on-device system 110 displays the transcript via an interactive graphical display of device 105.

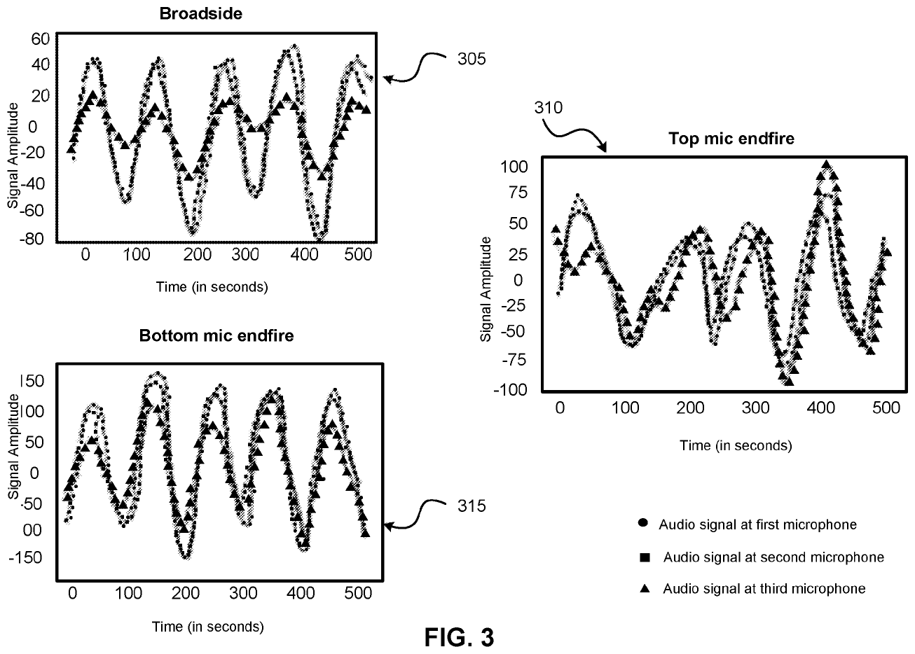

FIG. 3 illustrates example sample audio signals captured by three audio input devices, in accordance with example embodiments. Each of the three graphs 305, 310, and 315, represents a raw audio signal from three microphones. In each graph, the vertical axis represents an amplitude of the audio signal, and the horizontal axis represents time. As illustrated, beamforming based on two microphones in a phone may be used for localization. As illustrated, the bottom microphone endfire represented by graph 315 and the top microphone endfire represented by graph 310 have different maximum and minimum pics. Techniques for beamforming include a filter and sum (FAS) beamformer, and/or a minimum variance distortionless response (MVDR) beamformer.

The term “pics” as used herein, generally refers to a phase (or delay) between microphone signals. The term “broadside” means that the audio is arriving at the same time at each mic, so there is no delay. This is generally the case when the audio source is right in front of the microphone array. The term “endfire” means that the audio wave is arriving at one microphone much earlier than the other. This means the source is generally on the left or right side of the microphone array.

Beamforming is a spatial filter where sound delays can be used to boost audio arriving from certain directions. In some embodiments, a Filter and Sum (FAS) beamforming approach may be used, which is generally more computationally intensive than Delay and Sum (DAS), but it is more suitable for broadband speech signals.

The time-domain audio channels may be converted to the frequency domain. Each frequency bin can be filtered individually by multiplying by a steering weight (Eqn. 5), calculated from the microphone geometry (Eqn. 6). Multiplication in the frequency domain may be filtered in the time domain, so the steering weights may act as filters. Given an efficient Fast Fourier Transform (FFT) implementation, doing such filtering in the time domain may be more computationally intensive for a large number of filters as it would require convolutions instead of faster multiplications. Finally, the spectral domain signals can be summed in their respective frequency bins and transformed to single-output audio in the time domain. In some embodiments, a Hamming window with approximately 50% overlap may be used to reconstruct the audio. The FAS filter can be described in vector form as:

$$y ( t ) = {ℱ}^{- 1} ( {\sum }_{n = 1}^{N} {S}_{n}^{H} {X}_{n} ( f ) ) \qquad ( Eqn . 5 )$$

where y(t) is the single-channel audio output, S is the complex steering weight, as described in Equation 7, X(f) is the input audio transformed to the frequency domain, n is the microphone, with N total microphones, and H is the conjugate transpose.

Generally, the beam may be steered to any azimuth angle (θ) by adjusting the steering weights. For a circular microphone array, the individual complex steering weight of a microphone at a specific frequency may be computed as phase delays in the following way:

$$s ( f , θ , {θ}_{m} ) = {e}^{\frac{- 2 π fj}{c} r cos ( θ - {θ}_{m} )} \qquad ( Eqn . 6 )$$

where c is the speed of sound, s is the steering weight, f is the frequency, and θ is the desired steering azimuth angle. θₘ is the azimuth angle of the microphone in the circular array, and r is the radius of the circular array.

For a 4-microphone array, there can be a complex collection of steering weights as vectors, abbreviated as S. There can be steering weights for each frequency bin (total of N) and each microphone:

$$S = \{ s ( {f}_{0} , {θ}_{0} ) , s ( {f}_{0} , {θ}_{1} ) , s ( {f}_{0} , {θ}_{2} ) , s ( {f}_{0} , {θ}_{3} ) \} … \{ s ( {f}_{N} , {θ}_{0} ) , s ( {f}_{N} , {θ}_{1} ) , s ( {f}_{N} , {θ}_{2} ) , s ( {f}_{N} , {θ}_{3} ) \} \qquad ( Eqn . 7 )$$

In some embodiments, the Filter and Sum (FAS) beamformer may be further enhanced with Minimum Variance Distortionless Response Filter (MVDR). This technique adjusts the steering weights according to the noise measurements

In each graph, the curve represented using circles may correspond to the audio signal captured by microphone 240 (of FIG. 2), the curve represented using squares may correspond to the audio signal captured by microphone 245 (of FIG. 2), and the curve represented using triangles may correspond to the audio signal captured by microphone 235 (of FIG. 2). As illustrated in FIG. 2, microphones 215 and 220 are in close proximity near the top of device 230, and therefore the corresponding curves (represented with circles and squares) are substantially similar. On the other hand, microphone 235 is located toward the bottom of device 230, and therefore the corresponding curve (represented by triangles) has a different amplitude characteristic than the curves represented with circles and squares.

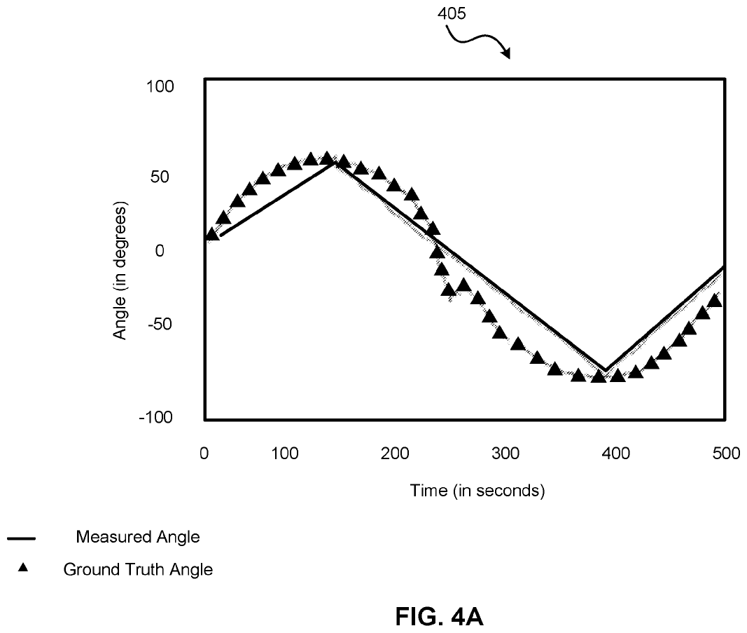

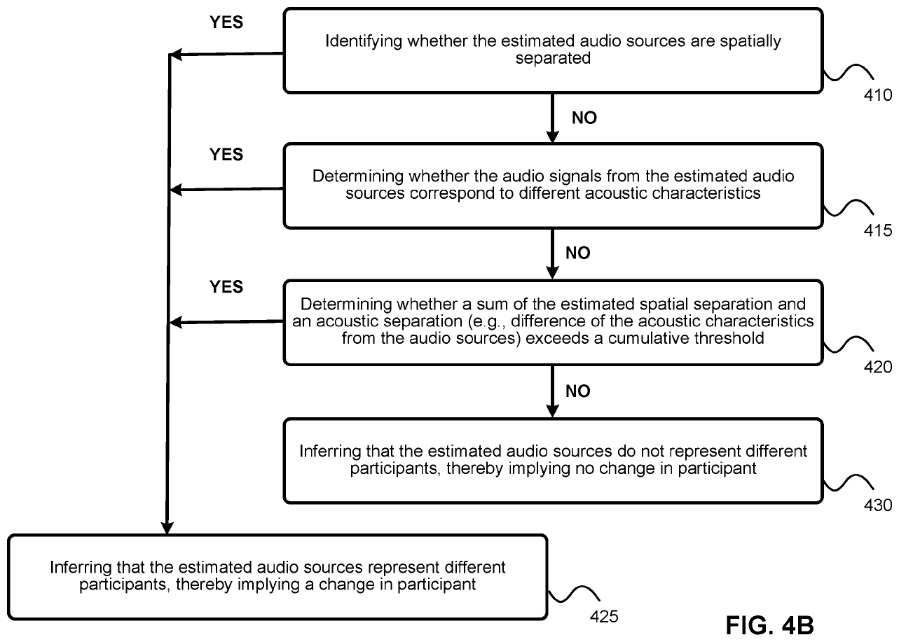

FIG. 4 illustrates an example for sound localization, in accordance with example embodiments. As illustrated, estimating time differences for sound arrival at top and bottom microphones may be used to estimate a direction to a sound source. For example, in graph 405, the horizontal axis represents time and the vertical axis represents angle for an audio source. The piecewise linear curve is ground truth data indicating two separate sources. The observed data is represented by the curve with triangles. As illustrated, the observed data also indicates two separate audio sources. To determine ground truth data, the device may be placed on a motorized rotating platform capable of collecting the ground truth data, as the device is rotated 180 degrees. The angles may then be determined from the motor position.

As illustrated in FIGS. 3 and 4, the primary contribution in these examples come from top and bottom microphones (microphones 210 and 220 respectively in FIG. 2) since the third microphone 240 is very close to the top microphone 245.

Referring again to FIG. 1, on-device system 110 can interface with speaker determination system 130. Speaker determination system 130 can be configured to associate, based on the estimated directions of the two audio sources, respective portions of a speech-to-text transcript of the conversation with the respective participants.

FIG. 4B illustrates an example flowchart for speaker identification, in accordance with example embodiments. An example flow for detecting a change in participant is described. Block 410 involves identifying if participants are located in different spatial directions. This can be done by determining whether the estimated audio sources are spatially separated. For example, based on the estimated audio sources, a spatial threshold can be used to determine whether the estimated audio sources represent different participants. Upon a determination that the estimated sources are spatially separated beyond the spatial threshold, the process proceeds to block 425. Block 425 involves inferring that the estimated audio sources represent separate participants, thereby implying a change in participant.

Upon a determination that the estimated sources are not spatially separated beyond the spatial threshold, the process proceeds to block 415. Block 415 involves determining whether the audio signals from the estimated audio sources correspond to different acoustic characteristics. For example, this may involve determining whether acoustic characteristics for the estimated audio sources differ by more than an acoustic threshold. Upon a determination that the audio signals from the estimated audio sources correspond to different acoustic characteristics, the process proceeds to block 425. Block 425 involves inferring that the estimated audio sources represent separate participants, thereby implying a change in participant.

Upon a determination that the audio signals from the estimated audio sources do not correspond to different acoustic characteristics, the process proceeds to block 420. For example, this may involve determining whether acoustic characteristics for the estimated audio sources fail to differ by more than an acoustic threshold.

Block 420 involves determining whether a sum of the estimated spatial separation and an acoustic separation (e.g., difference of the acoustic characteristics from the audio sources) exceeds a cumulative threshold. Upon a determination that the sum of the estimated spatial separation and the acoustic separation exceeds the cumulative threshold, the process proceeds to block 425. Block 425 involves inferring that the estimated audio sources represent separate participants, thereby implying a change in participant.

Finally, upon a determination that the sum of the estimated spatial separation and the acoustic separation fails to exceed the cumulative threshold, the process proceeds to block 430. Block 430 involves inferring that the estimated audio sources do not represent separate participants, thereby implying no change in participants.

At block 425, inferring that a change in participant has occurred may trigger on-device system 110 to identify the participant. In some embodiments, when the process reaches block 425 from block 410, then prior information about user location may be used to identify the participant. For example, a display of the user locations (via an interactive graphical user interface) may be used to identify the participant. In some embodiments, when the process reaches block 425 from block 415, then prior information about speech characteristics of a participant may be used to identify the participant. In case such individual methods fail to identify the participant, the two methods may be combined to identify the participant.

In some embodiments, estimating of the respective directions for two audio sources can involve synchronizing the speech-to-text transcript of the conversation with the synchronized first and second audio. For example, as each audio signal is received at each microphone with a time delay, there may be a corresponding delay in the transcription. Accordingly, the transcription is synchronized with the first and second audio signals. Some embodiments involve determining sample delays for respective transcript segments based on the synchronizing of the speech-to-text transcript. This allows for an accurate correlation of the audio signal delays and the transcription delays, and participant identification.

In some embodiments, a likely delay for respective transcript segments may be determined based on one or more of a histogram analysis or a kernel density estimate (KDE). Audio source estimation, and/or participant identification may be based on applying a threshold to the likely delay. For example, when the likely delay exceeds a threshold, this indicates separated audio sources. The transcript may be synchronized with TDOA data. Accordingly, diarization can be based on the angle of arrival of speech, assuming that the speakers are located at different places.

The aforementioned techniques allow flexibility in choosing a level of clarity for an acoustic model (for personalized speech characteristics) versus clarity for spatial direction for participants. For example when the participants in the group conversation are seated in different directions, less accurate acoustic methods may be used to distinguish them as different participants. Also, for example, when the participants sound very different (have different speech characteristics), then the sound localization level may be less accurate. Accordingly, quantifiable metrics may be determined to quantify accuracy of sound localization vis-a-vis identification of acoustic and/or participant models.

As described herein, sound localization can be used to identify an identity of a participant, and to select an acoustic model for participants that are located in directions corresponding to their sound sources. In some embodiments, a user can identify the location and/or the identity of one or more of the participants in the conversation via a digital image that captures the relative positions of the different participants. For example, one or more cameras may be used to capture digital images of the participants in a meeting. Also, for example, the digital images may be analyzed to detect movements, and participant identification may be updated accordingly.

For example, a digital image of four persons seated around a circular table may be generated and displayed on a user's device. The user may interact with the digital image and identify the other participants. For example, the user may add nicknames to each of the participants. Accordingly, on-device system 110 may associate the estimated audio sources with the nicknames. In some embodiments, the user may also orient a displayed image of the device (with the microphones) that may be placed on the circular table. This can reinforce the relative positions of the participants with reference to the microphones, resulting in better sound localization and tracking.

As indicated, the digital image may be an actual image or live video captured by one or more cameras. Image processing techniques (e.g., tracking motion vectors, determining luma changes, etc.) may be used to detect movement of the participants, and the association of the estimated audio sources to participants may be updated accordingly.

In some embodiments, speaker determination system 130 can receive, from transcription system 140, a transcription of the audio signal. Transcription system 140 can be configured to recognize speech and convert it to text to generate a speech-to-text transcript. For example, transcription system 140 can be a speech recognition system that is configured to recognize speech. In some embodiments, transcription system 140 can reside on device 105. In some embodiments, transcription system 140 can be an interface (e.g., an application programming interface) at device 105 for an input recognition system residing at a remote server. For example, a trained machine learning model can perform speech recognition to generate a transcription of the speech. Some embodiments involve receiving, from an input recognition model, a transcription of the input. For example, transcription system 140 such as, for example, a speech recognition system, can transcribe the speech input received by microphone(s) 115 and provide the transcription. The term “speech recognition” as used herein, can generally refer to any process that recognizes audio input and converts the audio input to a textual format. For example, microphone(s) 115 can receive the speech input in the form of human speech, and transcription system 140 can transcribe the human speech into text. In some embodiments, transcription system 140 can include one or more machine learning models that are trained to recognize speech.

Recognizing speech can be a challenging task. For example, there may be challenges due to the inherent complexities of various languages, and/or dialects therein. In some embodiments, there may be variations in the way speech is uttered by different individuals. For example, speech recognition can be especially challenging when a particular term is not recognized as a common term in a dictionary associated with a language. Although speech recognition systems can be trained to recognize different languages, accents, dialects, and so forth, such speech recognition systems may still be unable to recognize a word, or a phrase uttered by a user. Also, for example, such speech recognition systems may be located at a server remote from the device, and various data processing restrictions may limit an appropriate personalization of such systems, and/or network limitations may limit access to such remote servers. Accordingly, on-device processing may be preferred both for privacy and/or security controls, as well as to enable faster processing, less power consumption, lower latency, less data transmission over a network, and so forth.

In some embodiments, speech recognition can be performed by a remote server that interfaces with device 105 by an API (e.g., transcription system 140). In such embodiments, on-device system 110 can receive the audio signal and send the audio signal to the remote server. The remote server can apply a trained machine learning model to generate the transcription of the audio signal. Subsequently, on-device system 110 can receive the transcription from the remote server, and perform modifications of the transcription as needed.

In some embodiments, on-device system 110 can perform one or more operations, including scanning the transcription, filtering out common terms, performing contextual analysis, and so forth. On-device system 110 may then determine that the transcription is accurate (within appropriate thresholds of allowable accuracy), and no corrections are to be made. In some embodiments, on-device system 110 may identify one or more candidate terms that are likely to have been mistranscribed.

In some embodiments, accuracy of transcription of speech can be enhanced based on acoustic models that are personalized to a specific user. Accordingly, on-device system 110 can include speaker-based acoustic model 135 that can correct the transcription of the input by transcription system 140. For example, speaker-based acoustic model 135 can be trained to learn speech characteristics of a particular user.

For example, for training purposes, speech input can be received in the form of an audio signal. A feature extraction system can be configured to extract one or more features of the audio signal. Speaker-based acoustic model 135 can be trained to associate relationships between audio signal and phonemes or other linguistic properties that form speech audio. For example, speaker-based acoustic model 135 can be trained to identify and associate certain received utterances that exhibit acoustical characteristics that align with the acoustics associated with a spoken word or phrase.

In some embodiments, speaker-based acoustic model 135 can be configured to use a language model. The language model can specify or identify certain word combinations or sequences. In some implementations, the language model can be configured to generate a word sequence probability factor which can be used to indicate a likely occurrence or existence of particular word sequences or word combinations. The identified word sequences may correspond primarily to sequences that are specific to a speech corpus.

Transcription system 140 can be configured to receive input from speaker-based acoustic model 135 and the speaker determination system 130 to generate a transcript of the conversation. For example, transcription system 140 can be configured to include speech recognition logic, programmed instructions, and/or algorithms that are executed by one or more processors to transcribe the conversation. For example, transcription system 140 can execute program code to manage identification, extraction, and analysis of characteristics of the received audio signal. Further, transcription system 140 can execute comparator logic to compare characteristics of the received audio signal to various model parameters stored in speaker-based acoustic model 135 and the language model. Results of the comparison can yield text transcription outputs that correspond substantially to the conversation.

In some embodiments, transcription system 140 can be configured to generate a modified speech-to-text transcript of the conversation that labels the respective portions of the speech-to-text transcript with each of the distinct participants, and identifies a change in participant for accurate labeling. In some embodiments, on-device system 110 is configured to display the modified speech-to-text transcript, for example, in substantial real-time, contemporaneously with the conversation.

Although various components of FIG. 1 are shown to be on device 105 for illustrative purposes only, various additional and/or alternative embodiments are contemplated. For example, although speaker-based acoustic model 135 resides on device 105, one or more of the other components may also reside on device 105, at a remote server, or both. For example, transcription system 140 may reside on device 105. In some embodiments, transcription system 140 may reside at a remote server (e.g., a cloud server). Also, for example, certain portions of transcription system 140 may reside on device 105, whereas other portions can reside at the remote server. The speaker-based acoustic model 135 may be stored in a local repository of device 105. Also, for example, some embodiments involve restricting access to contents of the local repository to within device 105. Accordingly, heightened privacy controls may be applied to personalized acoustic models.

For example, on-device system 110 can receive the audio signal, and send the audio signal to a remote server for processing. Feature extraction can be performed by the remote server. Also, for example, at the remote server, transcription system 140 can utilize a language model to generate a transcription based on the audio signal, and send the transcription to device 105. On-device system 110 may then identify the participant based on estimated audio sources, and may generate a modified speech-to-text transcript of the conversation that labels the respective portions of the speech-to-text transcript associated with the respective participants. In some embodiments, a speaker-based acoustic model 135 may be utilized to further modify the transcript based on speech characteristics of a user.

Variations in user accent can be a source of errors in automatic speech recognition. A geographical or regional accent of a user can sometimes be determined by a user's location information Also, for example, a user's ethnicity can be indicative of ethnic dialects (e.g., ethnolect), variations in spellings, and so forth. For example, ethnic dialects can indicate an influence from a first language of the user, among other things. Some variational factors may also be inferred from user information. In some embodiments, preferences provided by the user can be used. For example, a user can be prompted to utter a sentence, and the speaker-based acoustic model 135 can infer nuances and speech characteristics that are unique to the user.

Generally speaking, speech characteristics may be determined by generating vector embeddings of the speech input (e.g. d-vector/speaker embeddings), followed by clustering methods or principal components analysis. As described, the acoustic model may be combined with sound localization to improve detection of a change in participant, and/or identification of a participant. For example, as described with reference to FIG. 4B, speech characteristics can be combined with sound localization by identifying audio sources and then applying the speech characteristics. One or more deep neural networks may be trained to predict the speech characteristics based on sample training speech data.

Further to the descriptions above, a user may be provided with controls allowing the user to make an election as to both if and when systems, programs, or features described herein may enable collection of user information (e.g., information about a user's ethnicity, gender, social network, social contacts, or activities, a user's preferences, or a user's current location, and so forth), and if the user is sent content or communications from a server. In addition, certain data may be treated in one or more ways before it is stored or used, so that personal data is removed, secured, encrypted, and so forth. For example, a user's identity may be treated so that no user data can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user. In addition to user controls, in embodiments where user information is used for speech recognition, such user information is restricted to the user's device, and is not shared with a server, and/or with other devices. Also, for example, the user may have an ability to delete or modify any user information.

In some embodiments, two categories of participants may be identified during a conversation. For example, a first category may include a first user who has non-standard speech, and is proximate to device 105. A second category may include other participants located further away from device 105 (relative to the first user). For example, device 105 may be equipped with microphones at the top and the bottom (e.g., see FIG. 2). Based on beamforming techniques and cross-correlation between the audio inputs from the two microphones, device 105 may identify when the first user is speaking, and when one of the other participants may be speaking. Accordingly, display of the transcript may be split into two screens, one screen displaying the portions of the transcript attributed to the first user, and a second screen displaying portions of the transcript attributed to the other participants.

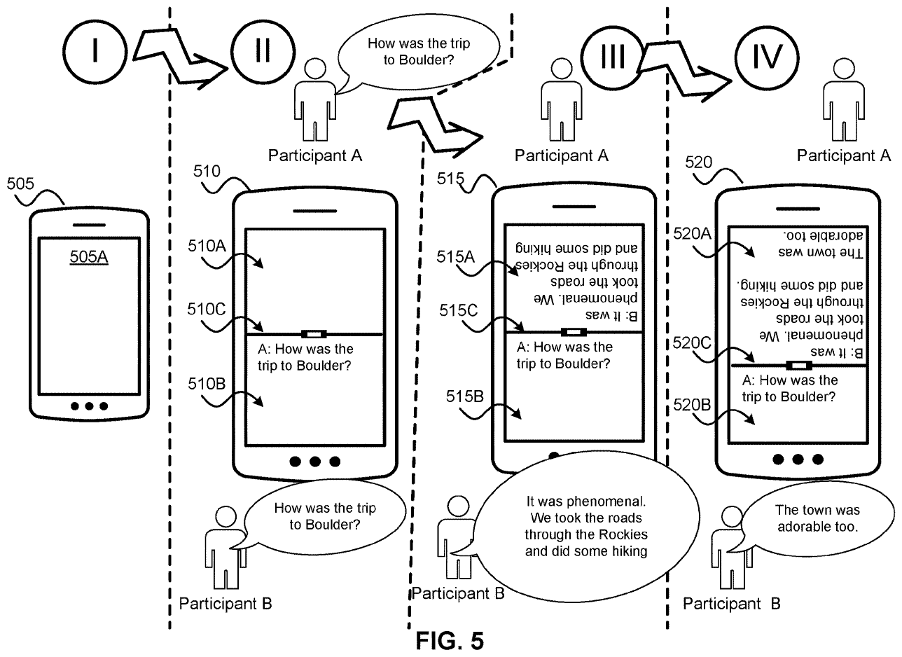

FIG. 5 illustrates an example split-screen display for speaker identification based on sound localization, in accordance with example embodiments. In some embodiments, top and bottom microphones of a smart device may be used to distinguish a user of the device from other participants located in front of the user. Display transcription may be provided on a split-screen and the text may be displayed with different characteristics (font, color, size, highlighted, etc.) based on sound localization and identification of the participants. Also, for example, the split-screen may be configured based on the reader of the relevant portion of the transcript. For example, in the example above, the first user who has non-standard speech may be provided with a view of the transcript corresponding to what the other participants are saying, whereas the other participants may be provided with a view of the transcript corresponding to what the first user is saying.

At phase I, device 505 is shown with a single display screen 505A. At phase II, participants A and B are shown located at opposite ends of device 510. Participant A may say, “How was the trip to Boulder?” Contemporaneously, single display screen 505A is now displayed in a split-screen format comprising a first portion 510A and a second portion 510B divided by divider 510C. Speech uttered by participant A is displayed on the second portion 510B. This provides participant B with a view of the transcript corresponding to what participant A is saying.

At phase III, participant B responds by saying, “It was phenomenal. We took the roads through the Rockies and did some hiking.” Contemporaneously, a first portion 515A of the split-screen format displays a transcription of the speech uttered by participant B. This provides participant A with a view of the transcript corresponding to what participant B is saying. The second portion 515B of the split-screen format is not updated as participant A has not spoken. The first portion 515A and the second portion 515B are divided by divider 515C.

Proceeding now to Phase IV, the second portion 520B of the split-screen format is not updated as participant A has not spoken. The first portion 520A and the second portion 520B are divided by divider 520C. However, as participant B continues to speak, the first portion 520A continues to be contemporaneously updated. For example, participant B may say, “The town was adorable too.” Accordingly, the first portion 520A is updated with a transcription of what participant B says. Also, for example, divider 520C may be adjusted dynamically (e.g., moved vertically down) to allocate more space to the first portion 520A. At subsequent phases, as participant A speaks again, divider 520C may be adjusted dynamically (e.g., moved vertically up) to allocate more space to the second portion 520B.

Also, for example, in the event participant B has non-standard speech, speaker-based acoustic model 135 (of FIG. 1) may be customized for participant B to suitably modify the transcript to accurately transcribe the speech uttered by participant B.

Continuing with this hypothetical, participants A and B may be located at a public place with several background speakers. In such circumstances, participant B, who is associated with the mobile device, may be able to identify participant A as a participant in the conversation. Accordingly, on-device system 110 may then transcribe the speech uttered by participant A and participant B and ignore other speech. Also, for example, participant B may be provided (via an interactive graphical user interface of the device), a digital rendering of the participants indicating a relative physical location of the participants based on the respective directions for the two audio sources. For example, the digital rendering may capture individuals located at a meeting, and participant B may be able to identify participants in the meeting, and/or identify who the relevant participants are. For example, on-device system 110 may utilize a facial recognition algorithm to identify faces in a digitally captured image, and participant B may identify the individuals that are participants in the conversation. For example, participant B may draw a circle around individuals seated on the left of a dinner table. Accordingly, on-device system 110 may not transcribe speech uttered by individuals seated on the right side of the table, and transcribe speech uttered by individuals seated on the left side of the table. Based on such user input, on-device system 110 may then transcribe the speech uttered by the identified participants only, and label the transcription accordingly.

### Training Machine Learning Models for Generating Inferences/Predictions

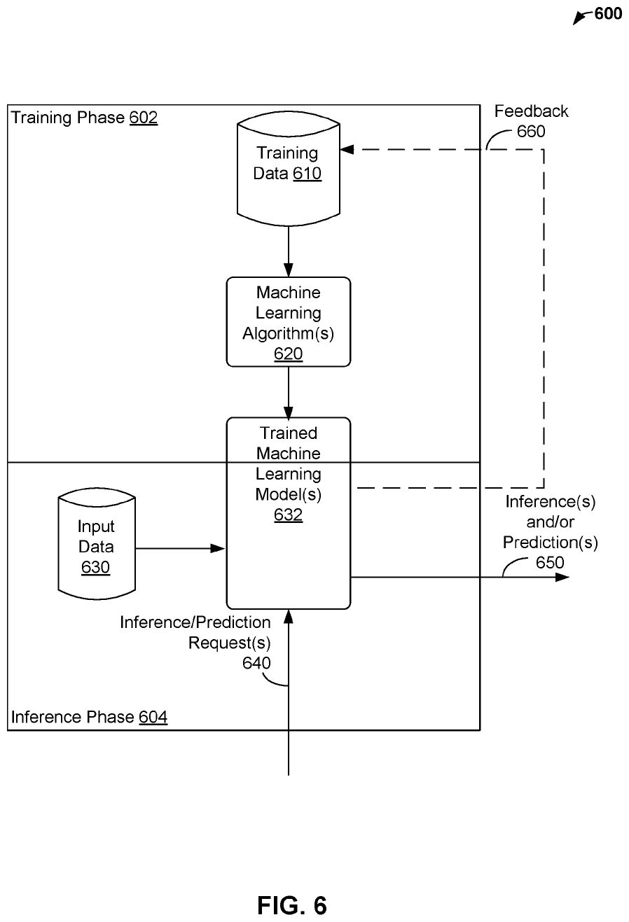

FIG. 6 shows diagram 600 illustrating a training phase 602 and an inference phase 604 of trained machine learning model(s) 632, in accordance with example embodiments. Some machine learning techniques involve training one or more machine learning algorithms on an input set of training data to recognize patterns in the training data and provide output inferences and/or predictions about (patterns in the) training data. The resulting trained machine learning algorithm can be termed as a trained machine learning model. For example, FIG. 6 shows training phase 602 where machine learning algorithm(s) 620 are being trained on training data 610 to become trained machine learning model(s) 632. Then, during inference phase 604, trained machine learning model(s) 632 can receive input data 630 and one or more inference/prediction requests 640 (perhaps as part of input data 630) and responsively provide as an output one or more inferences and/or prediction(s) 650.

As such, trained machine learning model(s) 632 can include one or more models of machine learning algorithm(s) 620. Machine learning algorithm(s) 620 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 620 may be supervised or unsupervised, and may implement any suitable combination of online and offline learning.

In some examples, machine learning algorithm(s) 620 and/or trained machine learning model(s) 632 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 620 and/or trained machine learning model(s) 632. In some examples, trained machine learning model(s) 632 can be trained, reside and execute to provide inferences on a particular computing device, and/or otherwise can make inferences for the particular computing device.

During training phase 602, machine learning algorithm(s) 620 can be trained by providing at least training data 610 as training input using unsupervised, supervised, semi-supervised, and/or reinforcement learning techniques. Unsupervised learning involves providing a portion (or all) of training data 610 to machine learning algorithm(s) 620 and machine learning algorithm(s) 620 determining one or more output inferences based on the provided portion (or all) of training data 610. Supervised learning involves providing a portion of training data 610 to machine learning algorithm(s) 620, with machine learning algorithm(s) 620 determining one or more output inferences based on the provided portion of training data 610, and the output inference(s) are either accepted or corrected based on correct results associated with training data 610. In some examples, supervised learning of machine learning algorithm(s) 620 can be governed by a set of rules and/or a set of labels for the training input, and the set of rules and/or set of labels may be used to correct inferences of machine learning algorithm(s) 620.

Semi-supervised learning involves having correct results for part, but not all, of training data 610. During semi-supervised learning, supervised learning is used for a portion of training data 610 having correct results, and unsupervised learning is used for a portion of training data 610 not having correct results. Reinforcement learning involves machine learning algorithm(s) 620 receiving a reward signal regarding a prior inference, where the reward signal can be a numerical value. During reinforcement learning, machine learning algorithm(s) 620 can output an inference and receive a reward signal in response, where machine learning algorithm(s) 620 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 620 and/or trained machine learning model(s) 632 can be trained using other machine learning techniques, including but not limited to, incremental learning and curriculum learning.

In some examples, machine learning algorithm(s) 620 and/or trained machine learning model(s) 632 can use transfer learning techniques. For example, transfer learning techniques can involve trained machine learning model(s) 632 being pre-trained on one set of data and additionally trained using training data 610. More particularly, machine learning algorithm(s) 620 can be pre-trained on data from one or more computing devices and a resulting trained machine learning model provided to a particular computing device, where the particular computing device is intended to execute the trained machine learning model during inference phase 604. Then, during training phase 602, the pre-trained machine learning model can be additionally trained using training data 610, where training data 610 can be derived from kernel and non-kernel data of the particular computing device. This further training of the machine learning algorithm(s) 620 and/or the pre-trained machine learning model using training data 610 of the particular computing device's data can be performed using either supervised or unsupervised learning. Once machine learning algorithm(s) 620 and/or the pre-trained machine learning model has been trained on at least training data 610, training phase 602 can be completed. The trained resulting machine learning model can be utilized as at least one of trained machine learning model(s) 632.

In particular, once training phase 602 has been completed, trained machine learning model(s) 632 can be provided to a computing device, if not already on the computing device. Inference phase 604 can begin after trained machine learning model(s) 632 are provided to the particular computing device.

During inference phase 604, trained machine learning model(s) 632 can receive input data 630 and generate and output one or more corresponding inferences and/or prediction(s) 650 about input data 630. As such, input data 630 can be used as an input to trained machine learning model(s) 632 for providing corresponding inference(s) and/or prediction(s) 650 to kernel components and non-kernel components. For example, trained machine learning model(s) 632 can generate inference(s) and/or prediction(s) 650 in response to one or more inference/prediction requests 640. In some examples, trained machine learning model(s) 632 can be executed by a portion of other software. For example, trained machine learning model(s) 632 can be executed by an inference or prediction daemon to be readily available to provide inferences and/or predictions upon request. Input data 630 can include data from the particular computing device executing trained machine learning model(s) 632 and/or input data from one or more computing devices other than the particular computing device.

Input data 630 can include a non-common term. Other types of input data are possible as well. Inference(s) and/or prediction(s) 650 can include one or more alternative terms that represent phonetically similar alternatives of pronouncing a non-common term. Inference(s) and/or prediction(s) 650 can include other output data produced by trained machine learning model(s) 632 operating on input data 630 (and training data 610). In some examples, trained machine learning model(s) 632 can use output inference(s) and/or prediction(s) 650 as input feedback 660. Trained machine learning model(s) 632 can also rely on past inferences as inputs for generating new inferences.

Convolutional neural networks and/or deep neural networks used herein can be an example of machine learning algorithm(s) 620. After training, the trained version of a convolutional neural network can be an example of trained machine learning model(s) 632. In this approach, an example of the one or more inference/prediction requests 640 can be a request to predict one or more terms in a transcript to substitute a non-common term spoken by a participant, and a corresponding example of inferences and/or prediction(s) 650 can be the output one or more substitute terms.

### Example Data Network

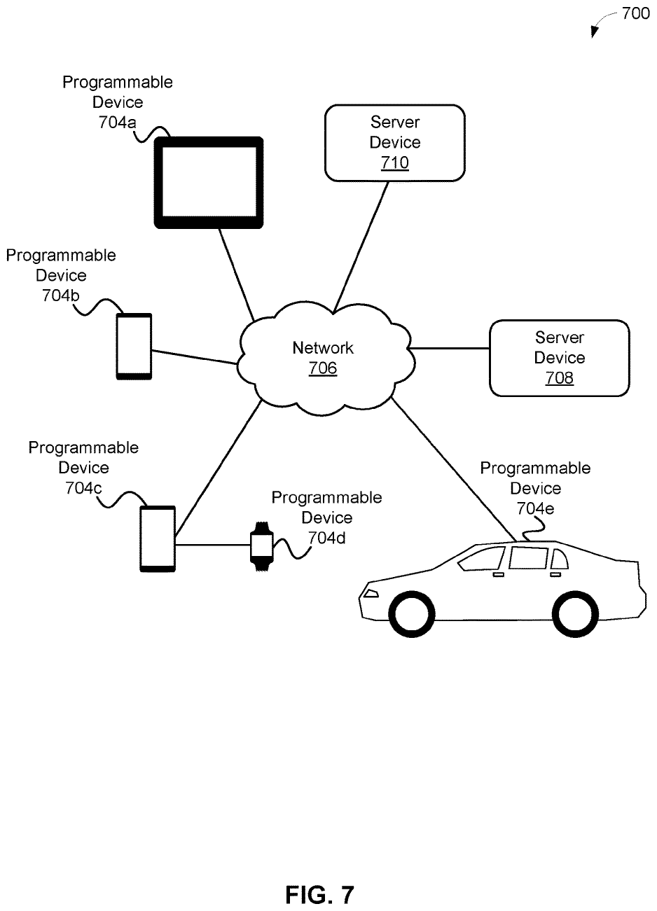

FIG. 7 depicts a distributed computing architecture 700, in accordance with example embodiments. Distributed computing architecture 700 includes server devices 708, 710 that are configured to communicate, via network 706, with programmable devices 704a, 704b, 704c, 704d, 704e. Network 706 may correspond to a local area network (LAN), a wide area network (WAN), a WLAN, a WWAN, a corporate intranet, the public Internet, or any other type of network configured to provide a communications path between networked computing devices. Network 706 may also correspond to a combination of one or more LANs, WANs, corporate intranets, and/or the public Internet.

Although FIG. 7 only shows five programmable devices, distributed application architectures may serve tens, hundreds, or thousands of programmable devices. Moreover, programmable devices 704a, 704b, 704c, 704d, 704e (or any additional programmable devices) may be any sort of computing device, such as a mobile computing device, desktop computer, wearable computing device, head-mountable device (HMD), network terminal, a mobile computing device, and so on. In some examples, such as illustrated by programmable devices 704a, 704b, 704c, 704e, programmable devices can be directly connected to network 706. In other examples, such as illustrated by programmable device 704d, programmable devices can be indirectly connected to network 706 via an associated computing device, such as programmable device 704c. In this example, programmable device 704c can act as an associated computing device to pass electronic communications between programmable device 704d and network 706. In other examples, such as illustrated by programmable device 704e, a computing device can be part of and/or inside a vehicle, such as a car, a truck, a bus, a boat or ship, an airplane, etc. In other examples not shown in FIG. 7, a programmable device can be both directly and indirectly connected to network 706.

Server devices 708, 710 can be configured to perform one or more services, as requested by programmable devices 704a-704e. For example, server device 708 and/or 710 can provide content to programmable devices 704a-704e. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server devices 708 and/or 710 can provide programmable devices 704a-704e with access to software for database, search, computation, graphical, audio, video, World Wide Web/Internet utilization, and/or other functions. Many other examples of server devices are possible as well.

### Computing Device Architecture

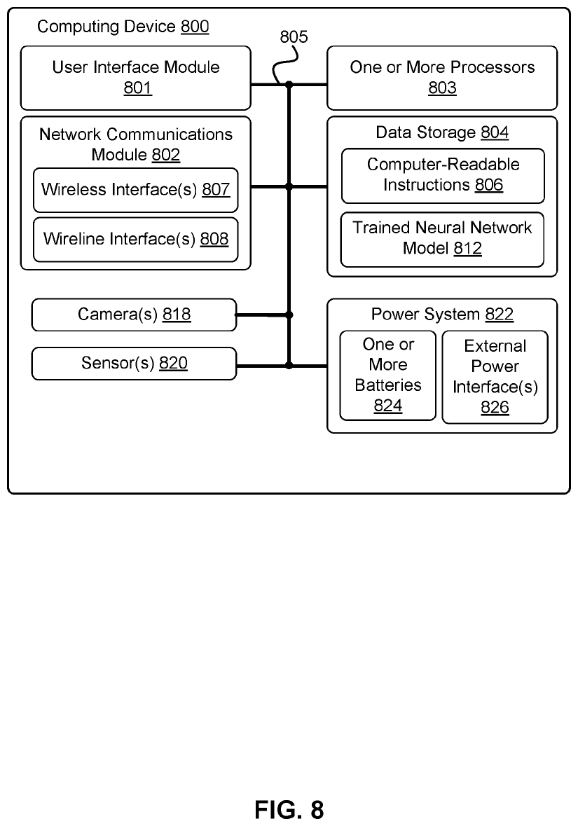

FIG. 8 is a block diagram of an example computing device 800, in accordance with example embodiments. In particular, computing device 800 shown in FIG. 8 can be configured to perform at least one function of and/or related to speaker identification based on sound localization as described herein, including in method 900, and/or method 1000.

Computing device 800 may include a user interface module 801, a network communications module 802, one or more processors 803, data storage 804, one or more camera(s) 818, one or more sensors 820, and power system 822, all of which may be linked together via a system bus, network, or other connection mechanism 805.

User interface module 801 can be operable to send data to and/or receive data from external user input/output devices. For example, user interface module 801 can be configured to send and/or receive data to and/or from user input devices such as a touch screen, a computer mouse, a keyboard, a keypad, a touch pad, a trackball, a joystick, a voice recognition module, and/or other similar devices. User interface module 801 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 801 can also be configured to generate audible outputs, with devices such as a speaker, speaker jack, audio output port, audio output device, earphones, and/or other similar devices. User interface module 801 can further be configured with one or more haptic devices that can generate haptic outputs, such as vibrations and/or other outputs detectable by touch and/or physical contact with computing device 800. In some examples, user interface module 801 can be used to provide a graphical user interface (GUI) for utilizing computing device 800. The GUI may display a transcript, a digital rendering of participants in a conversation, and receive user inputs.

Network communications module 802 can include one or more devices that provide wireless interface(s) 807 and/or wireline interface(s) 808 that are configurable to communicate via a network. Wireless interface(s) 807 can include one or more wireless transmitters, receivers, and/or transceivers, such as a Bluetooth™ transceiver, a Zigbee® transceiver, a Wi-Fi™ transceiver, a WiMAX™ transceiver, an LTE™ transceiver, and/or other type of wireless transceiver configurable to communicate via a wireless network. Wireline interface(s) 808 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some examples, network communications module 802 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 803 can include one or more general purpose processors, and/or one or more special purpose processors (e.g., digital signal processors, tensor processing units (TPUs), graphics processing units (GPUs), application specific integrated circuits, etc.). One or more processors 803 can be configured to execute computer-readable instructions 806 that are contained in data storage 804 and/or other instructions as described herein.

Data storage 804 can include one or more non-transitory computer-readable storage media that can be read and/or accessed by at least one of one or more processors 803. The one or more computer-readable storage media can include volatile and/or non-volatile storage components, such as optical, magnetic, organic or other memory or disc storage, which can be integrated in whole or in part with at least one of one or more processors 803. In some examples, data storage 804 can be implemented using a single physical device (e.g., one optical, magnetic, organic or other memory or disc storage unit), while in other examples, data storage 804 can be implemented using two or more physical devices.

Data storage 804 can include computer-readable instructions 806 and perhaps additional data. In some examples, data storage 804 can include storage required to perform at least part of the herein-described methods, scenarios, and techniques and/or at least part of the functionality of the herein-described devices and networks. In some examples, data storage 804 can include storage for a trained neural network model 812 (e.g., a model of trained convolutional neural networks). In particular of these examples, computer-readable instructions 806 can include instructions that, when executed by the one or more processors 803, enable computing device 800 to provide for some or all of the functionality of trained neural network model 812.

In some examples, computing device 800 can include camera(s) 818. Camera(s) 818 can include one or more image capture devices, such as still and/or video cameras, equipped to capture light and record the captured light in one or more images; that is, camera(s) 818 can generate image(s) of captured light. The one or more images can be one or more still images and/or one or more images utilized in video imagery. Camera(s) 818 can capture light and/or electromagnetic radiation emitted as visible light, infrared radiation, ultraviolet light, and/or as one or more other frequencies of light. For example, camera(s) 818 can be used to capture digital views of participants in a conversation for purposes of rendering the participants via a display, and/or for purposes of applying facial recognition algorithms to identify a participant, based on prior authorization from the participant.

In some examples, computing device 800 can include one or more sensors 820. Sensors 820 can be configured to measure conditions within computing device 800 and/or conditions in an environment of computing device 800 and provide data about these conditions. For example, sensors 820 can include one or more of: (i) sensors for obtaining data about computing device 800, such as, but not limited to, a thermometer for measuring a temperature of computing device 800, a battery sensor for measuring power of one or more batteries of power system 822, and/or other sensors measuring conditions of computing device 800; (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information; (iii) sensors to measure locations and/or movements of computing device 800, such as, but not limited to, a tilt sensor, a gyroscope, an accelerometer, a Doppler sensor, a GPS device, a sonar sensor, a radar device, a laser-displacement sensor, and a compass; (iv) an environmental sensor to obtain data indicative of an environment of computing device 800, such as, but not limited to, an infrared sensor, an optical sensor, a light sensor, a biosensor, a capacitive sensor, a touch sensor, a temperature sensor, a wireless sensor, a radio sensor, a movement sensor, a microphone, a sound sensor, an ultrasound sensor and/or a smoke sensor; and/or (v) a force sensor to measure one or more forces (e.g., inertial forces and/or G-forces) acting about computing device 800, such as, but not limited to one or more sensors that measure: forces in one or more dimensions, torque, ground force, friction, and/or a zero moment point (ZMP) sensor that identifies ZMPs and/or locations of the ZMPs. Many other examples of sensors 820 are possible as well.

Power system 822 can include one or more batteries 824 and/or one or more external power interfaces 826 for providing electrical power to computing device 800. Each battery of the one or more batteries 824 can, when electrically coupled to the computing device 800, act as a source of stored electrical power for computing device 800. One or more batteries 824 of power system 822 can be configured to be portable. Some or all of one or more batteries 824 can be readily removable from computing device 800. In other examples, some or all of one or more batteries 824 can be internal to computing device 800, and so may not be readily removable from computing device 800. Some or all of one or more batteries 824 can be rechargeable. For example, a rechargeable battery can be recharged via a wired connection between the battery and another power supply, such as by one or more power supplies that are external to computing device 800 and connected to computing device 800 via the one or more external power interfaces. In other examples, some or all of one or more batteries 824 can be non-rechargeable batteries.

One or more external power interfaces 826 of power system 822 can include one or more wired-power interfaces, such as a USB cable and/or a power cord, that enable wired electrical power connections to one or more power supplies that are external to computing device 800. One or more external power interfaces 826 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 826, computing device 800 can draw electrical power from the external power source the established electrical power connection. In some examples, power system 822 can include related sensors, such as battery sensors associated with one or more batteries or other types of electrical power sensors.

### Example Methods of Operation

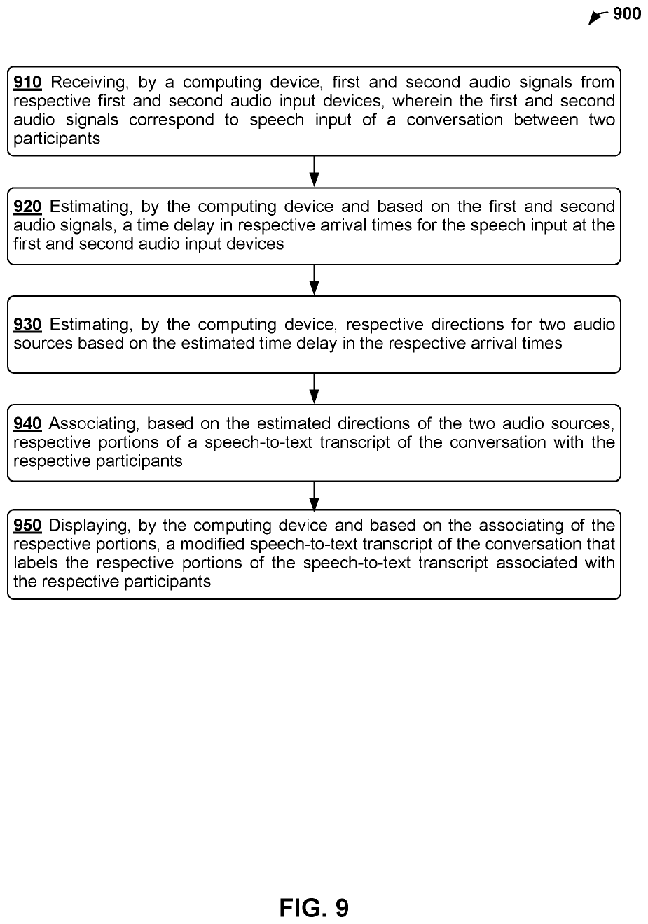

FIG. 9 is a flowchart of a method 900, in accordance with example embodiments. Method 900 can be executed by a computing device, such as computing device 800. Method 900 can begin at block 910, where the method involves receiving, by a computing device, first and second audio signals from respective first and second audio input devices, wherein the first and second audio signals correspond to speech input of a conversation between two participants.

At block 920, the method further involves estimating, by the computing device and based on the first and second audio signals, a time delay in respective arrival times for the speech input at the first and second audio input devices.

At block 930, the method also involves estimating, by the computing device, respective directions for two audio sources based on the estimated time delay in the respective arrival times.

At block 940, the method additionally involves associating, based on the estimated directions of the two audio sources, respective portions of a speech-to-text transcript of the conversation with the respective participants.

At block 950, the method further involves displaying, by the computing device and based on the associating of the respective portions, a modified speech-to-text transcript of the conversation that labels the respective portions of the speech-to-text transcript associated with the respective participants.

In some embodiments, the displaying of the modified speech-to-text transcript involves displaying the modified speech-to-text transcript in a split-screen format comprising a respective window for the respective participants, and wherein each respective window displays text corresponding to the respective participant contemporaneously as the respective participant speaks.

Some embodiments also involve displaying a digital rendering of the two participants indicating a relative physical location of the two participants based on the respective directions for the two audio sources. Such embodiments may involve receiving, at the computing device, user input indicating an identity of the two participants, where the digital rendering comprises the identity of the two participants. Such embodiments may involve detecting a movement of one or both of the two participants. Such embodiments may also involve adjusting the digital rendering based on the detected movement. In some embodiments, the displaying of the digital rendering may be based on a digital image of the two participants as captured by a camera.

In some embodiments, the computing device may be associated with a first participant of the two participants. Such embodiments involve applying, by the computing device, an acoustic model associated with the first participant, where the first participant is proximate to the computing device. The modified transcript may be based on the acoustic model. In some embodiments, the acoustic model may be stored in a local repository of the computing device. Such embodiments involve restricting access to contents of the local repository to within the computing device.

In some embodiments, the conversation comprises one or more additional speakers. Such embodiments involve receiving user indication that the one or more additional speakers are not participants of the conversation. The speech-to-text transcript does not transcribe speech input from the one or more additional speakers.

In some embodiments, the first and second audio signals are synchronized. In such embodiments, the estimating of the time delay in respective arrival times involves applying generalized cross-correlation with phase transform (GCC-PHAT) to the synchronized first and second audio signals.

In some embodiments, the estimating of the respective directions for two audio sources involves synchronizing the speech-to-text transcript of the conversation with the synchronized first and second audio signals. Such embodiments also involve determining sample delays for respective transcript segments based on the synchronizing of the speech-to-text transcript.

In some embodiments, the determining of the sample delays for respective transcript segments involves determining a likely delay based on one or more of a histogram analysis or a kernel density estimate (KDE). In such embodiments, the estimating of the respective directions for two audio sources involves applying a threshold to the determined likely delay.

In some embodiments, the estimating of the respective directions for the two audio sources involves correlating the time delay in respective arrival times with relative locations of the first and second audio input devices.

Some embodiments involve receiving, from an automatic speech recognition model, the speech-to-text transcript of the conversation.

In some embodiments, the conversation may include a third participant. In such embodiments, the estimating of the time delay involves estimating, by the computing device, respective directions for three audio sources based on the estimated time delay in the respective arrival times. Some embodiments also involve associating, based on the estimated directions of the three audio sources, the respective portions of the speech-to-text transcript of the conversation with each of the three participants. In such embodiments, the modified speech-to-text transcript of the conversation may include labels identifying each of the three participants.

Some embodiments involve receiving speech input at a third audio input device. In such embodiments, the estimating of the time delay in respective arrival times comprises estimating pairwise time delays for respective audio signals from each pair of the three audio input devices.

Some embodiments involve selecting, for the respective participants corresponding to the estimated directions for the two audio sources, a respective acoustic model indicative of speech characteristics of a respective participant. In such embodiments, the modified speech-to-text transcript of the conversation may be based on the selected acoustic models. In such embodiments, the selecting of the respective acoustic model may involve generating a d-vector embedding for the speech input. Such embodiments also involve classifying the two participants based on the embedding, wherein the classifying comprises one of a clustering technique or a principal component analysis.

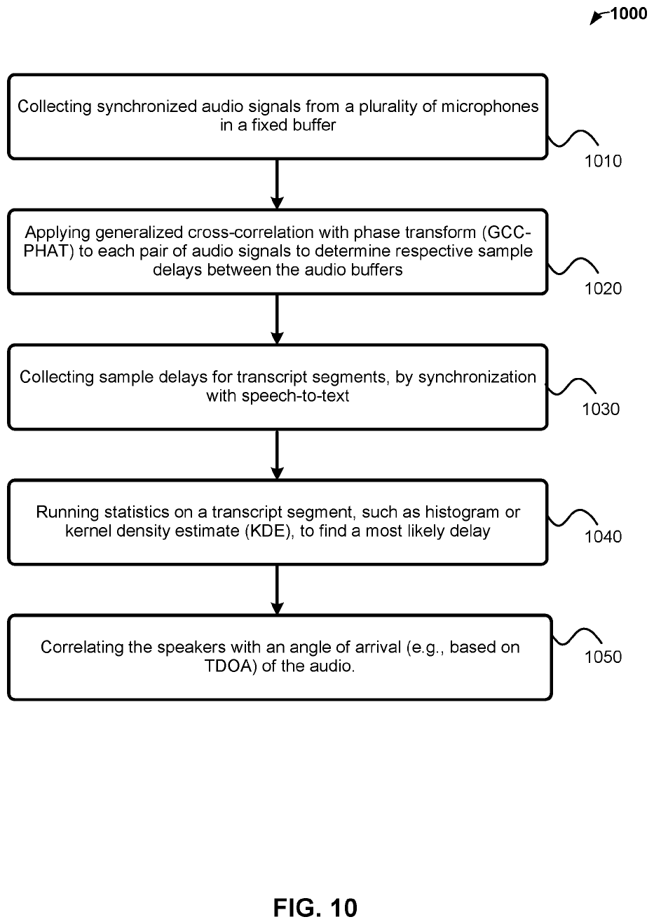

FIG. 10 is a flowchart of a method 1000, in accordance with example embodiments. Method 1000 can be executed by a computing device, such as computing device 800. Method 1000 can begin at block 1010, where the method involves collecting synchronized audio signals from a plurality of microphones in a fixed buffer.

At block 1020, the method further involves applying generalized cross-correlation with phase transform (GCC-PHAT) to each pair of audio signals (corresponding to a respective pair of microphones) to determine respective sample delays between the audio buffers.

At block 1030, the method also involves collecting sample delays for transcript segments, by synchronization with the speech-to-text.

At block 1040, the method additionally involves running statistics on a transcript segment, such as histogram or kernel density estimate (KDE), to find a most likely delay.

At block 1050, the method additionally involves correlating the speakers with an angle of arrival (e.g., based on TDOA) of the audio.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as non-transitory computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

With respect to embodiments that include determining a non-common term based on user interaction with a computing device, and/or determining alternative terms using a machine learning model, or interactions by the computing device with cloud-based servers, a user may be provided with controls allowing the user to make an election as to both if and when systems, programs, or features described herein may enable collection of user information (e.g., information about a user's social network, social actions, or activities, profession, a user's preferences, a user's demographic information, a user's current location, or other personal information), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While various aspects and embodiments have been disclosed herein, other aspects and embodiments will be apparent to those skilled in the art. The various aspects and embodiments disclosed herein are provided for explanatory purposes and are not intended to be limiting, with the true scope being indicated by the following claims.

What is claimed is:

1. A computer-implemented method, comprising:
receiving, by a computing device, first and second audio signals from respective first and second audio input devices, wherein the first and second audio signals correspond to speech input of a conversation between two participants;
estimating, by the computing device and based on the first and second audio signals, a time delay in respective arrival times for the speech input at the first and second audio input devices;
estimating, by the computing device, respective directions for two audio sources based on the estimated time delay in the respective arrival times;
associating, based on the estimated directions of the two audio sources, respective portions of a speech-to-text transcript of the conversation with the respective participants; and
displaying, by the computing device and based on the associating of the respective portions, a modified speech-to-text transcript of the conversation that labels the respective portions of the speech-to-text transcript associated with the respective participants.

2. The computer-implemented method of claim 1, wherein the displaying of the modified speech-to-text transcript further comprises:
displaying the modified speech-to-text transcript in a split-screen format comprising a respective window for the respective participants, and wherein each respective window displays text corresponding to the respective participant contemporaneously as the respective participant speaks.

3. The computer-implemented method of claim 1, further comprising:
displaying a digital rendering of the two participants indicating a relative physical location of the two participants based on the respective directions for the two audio sources.

4. The computer-implemented method of claim 3, further comprising:
receiving, at the computing device, user input indicating an identity of the two participants, and
wherein the digital rendering comprises the identity of the two participants.

5. The computer-implemented method of claim 3, further comprising:
detecting a movement of one or both of the two participants; and
adjusting the digital rendering based on the detected movement.

6. The computer-implemented method of claim 3, wherein the displaying of the digital rendering is based on a digital image or a video of the two participants as captured by a camera.

7. The computer-implemented method of claim 1, wherein the computing device is associated with a first participant of the two participants, and further comprising:
applying, by the computing device, an acoustic model associated with the first participant, wherein the first participant is proximate to the computing device, and
wherein the modified transcript is based on the acoustic model.

8. The computer-implemented method of claim 7, wherein the acoustic model is stored in a local repository of the computing device, and further comprising:
restricting access to contents of the local repository to within the computing device.

9. The computer-implemented method of claim 1, wherein the conversation comprises one or more additional speakers, and further comprising:
receiving user indication that the one or more additional speakers are not participants of the conversation, and
wherein the speech-to-text transcript does not transcribe speech input from the one or more additional speakers.

10. The computer-implemented method of claim 1, wherein the first and second audio signals are synchronized, and wherein the estimating of the time delay in respective arrival times further comprises:
applying generalized cross-correlation with phase transform (GCC-PHAT) to the synchronized first and second audio signals.

11. The computer-implemented method of claim 10, wherein the estimating of the respective directions for the two audio sources further comprises:
synchronizing the speech-to-text transcript of the conversation with the synchronized first and second audio signals; and
determining sample delays for respective transcript segments based on the synchronizing of the speech-to-text transcript.

12. The computer-implemented method of claim 11, wherein the determining of the sample delays for respective transcript segments further comprises:
determining a likely delay based on one or more of a histogram analysis or a kernel density estimate (KDE), and
wherein the estimating of the respective directions for the two audio sources comprises applying a threshold to the determined likely delay.

13. The computer-implemented method of claim 1, wherein the estimating of the respective directions for the two audio sources further comprises:
correlating the time delay in respective arrival times with relative locations of the first and second audio input devices.

14. The computer-implemented method of claim 1, further comprising:
receiving, from an automatic speech recognition model, the speech-to-text transcript of the conversation.

15. The computer-implemented method of claim 1, wherein the conversation includes a third participant, and wherein the estimating of the time delay further comprises:
estimating, by the computing device, respective directions for three audio sources based on the estimated time delay in the respective arrival times; and
associating, based on the estimated directions of the three audio sources, the respective portions of the speech-to-text transcript of the conversation with each of the three participants, and
wherein the modified speech-to-text transcript of the conversation includes labels identifying each of the three participants.

16. The computer-implemented method of claim 1, further comprising:
receiving the speech input at a third audio input device, and
wherein the estimating of the time delay in respective arrival times comprises estimating pairwise time delays for respective audio signals from each pair of the three audio input devices.

17. The computer-implemented method of claim 1, further comprising:
selecting, for one or both of the two participants corresponding to the estimated directions for the two audio sources, a respective acoustic model indicative of speech characteristics of a respective participant, and
wherein the modified speech-to-text transcript of the conversation is based on the selected acoustic models.

18. The computer-implemented method of claim 17, wherein the selecting of the respective acoustic model comprises:
generating a d-vector embedding for the speech input; and
classifying the two participants based on the embedding, wherein the classifying comprises one of a clustering technique or a principal component analysis.

19. A computing device, comprising:
one or more processors; and
data storage, wherein the data storage has stored thereon computer-executable instructions that, when executed by the one or more processors, cause the computing device to carry out functions comprising:
receiving, by the computing device, first and second audio signals from respective first and second audio input devices, wherein the first and second audio signals correspond to speech input of a conversation between two participants;
estimating, by the computing device and based on the first and second audio signals, a time delay in respective arrival times for the speech input at the first and second audio input devices;
estimating, by the computing device, respective directions for two audio sources based on the estimated time delay in the respective arrival times;
associating, based on the estimated directions of the two audio sources, respective portions of a speech-to-text transcript of the conversation with the respective participants; and
displaying, by the computing device and based on the associating of the respective portions, a modified speech-to-text transcript of the conversation that labels the respective portions of the speech-to-text transcript associated with the respective participants.

20. An article of manufacture comprising one or more computer readable media having computer-readable instructions stored thereon that, when executed by one or more processors of a computing device, cause the computing device to carry out functions comprising:
receiving, by the computing device, first and second audio signals from respective first and second audio input devices, wherein the first and second audio signals correspond to speech input of a conversation between two participants;
estimating, by the computing device and based on the first and second audio signals, a time delay in respective arrival times for the speech input at the first and second audio input devices;
estimating, by the computing device, respective directions for two audio sources based on the estimated time delay in the respective arrival times;
associating, based on the estimated directions of the two audio sources, respective portions of a speech-to-text transcript of the conversation with the respective participants; and
displaying, by the computing device and based on the associating of the respective portions, a modified speech-to-text transcript of the conversation that labels the respective portions of the speech-to-text transcript associated with the respective participants.
